(19) United States
(12) Patent Application Publication
(10) Pub. No.: US 2017/0351988 A1
(43) Pub. Date: Dec. 7, 2017

(54) PLATFORM/SYSTEM FOR THE PRICING, BIDDING, AWARD AND MANAGEMENT OF FLEET-BASED INSTALLATION SERVICES

(71) Applicant: Modagrafics, Inc., Rolling Meadows, IL (US)

(72) Inventors: Paul Robert Pirkle, Naperville, IL (US); Michael L. Antongiovanni, Crystal Lake, IL (US)

(21) Appl. No.: 15/612,786

(22) Filed: Jun. 2, 2017

Related U.S. Application Data
(60) Provisional application No. 62/345,116, filed on Jun. 3, 2016.

(51) Int. Cl. G06Q 10/06; G06Q 30/08; G06Q 30/04; G06K 7/10; H04L 29/08; G06Q 10/08

(52) U.S. Cl. CPC G06Q 10/06313; G06Q 30/04; G06K 7/10861; G06Q 30/08; G06Q 10/087; H04L 67/34

(57) ABSTRACT

A computer-implemented platform and system designed for the pricing, bidding, award, and management of fleet-based installation services and associated goods. More specifically the system and platform is an app-based software-enabled platform and system designed to manage services performed on a fleet of vehicles which includes upgrading and updating a graphical component on the external surface of the vehicles of the fleet. The system also allows for the management of other decorative art to be installed on surfaces and the process associated thereof.

The present utility patent application claims priority from and the benefit of U.S. Provisional Patent Application No. 62/345,116 filed Jun. 3, 2016, the contents of which are hereby incorporated by reference in their entirety.

### FIELD OF THE INVENTION

The present disclosure relates to a computer-implemented platform for the pricing, bidding, award, and management of fleet-based installation services, and more specifically, to an app-based software-enabled platform and system designed to manage services performed on a fleet of vehicle owned by a client which includes upgrading and updating a graphical component on the external surface of the vehicles of the fleet.

### BACKGROUND OF THE INVENTION

Before the arrival of technology, the only way to place illustrations, artwork, and other types of graphics onto physical items was to manually paint portraits and other illustrations onto a surface such as canvas or on the outside surface of buildings. These works were manually drawn by artists. This process was time consuming, required great skill, was variable, and resulted in only a handful of surfaces being covered with art each year. Weather conditions also could destroy any artwork placed on surfaces located outdoors. Today, only rare examples remain of this precursory concept of covering surfaces with art and illustrations. For example, a building façade is hand-painted by local artists each year in Chicago to celebrate the annual Chicago Marathon and commemorate other events. Drivers on Interstate 94 can see these works change each year.

Over the years, substantial improvements and new innovations have been implemented in the art of surface decoration. Mankind invented the printing press and began mass-producing illustrations on media like paper. Building murals and large billboards are today often created by being covered with a series of vertical rolls of paper assembled to form a large picture. As one can imagine, this process is far from perfect. Printing is required, a person must then climb the billboard and, using glue, assemble the images. A third substantial improvement came when a television screen could be made in an extremely large size. Today, some billboards are covered by LEDs and with the flip of a switch in a computer, the image on the billboard changes. In these cases, the decoration can only be placed on a flat surface. Decoration of uneven surfaces remained mostly manual; for example, decorators still paint furniture, vehicles, and rooms inside buildings. What is needed is a way to better decorate even and uneven surfaces, which allows completion of the transition from manual work to automated work.

A solution has partly been made possible by the arrival in the 20th century of computers. Images began to be digitized, photography also became electronic and so did part of the process of printing. Using new semitransparent media, high-speed printing, and three dimensional rendering, images are now being printed on weather-resistant materials, such as polymers, which in turn can be placed on different surfaces including uneven surfaces. But as this technology evolves, so does consumer need for customized goods in trade.

In the past, because of the costs and labor associated with the process of manufacture and advertising, products and advertising campaigns were only mass-produced or made in series. One single car was designed and manufactured. One large advertising campaign was produced and ads were sent to the media. Substantial new steps in these fields appeared when computers and digitized technology as a whole helped reduce the barrier of scale. As a consequence, smaller series are now produced but because the scale barrier has partly fallen, more models of vehicles and furniture are now available to the consumer. Where consumers once had a handful of choices in terms of music bands, jeans, soft drinks, and even cars, today they are given more choice. Proportionally, marketing now needs to adapt and create customized campaigns capable of selling and marketing smaller-sized series of items.

What is needed are electronic and software-enabled tools that allow for better management of the process of manufacturing goods for use in marketing campaigns. Tools which help streamline these processes make the cost of marketing of fewer numbers of series more affordable, which in turn allow a greater number of products to reach consumers thus helping improve the overall quality of modern life.

### BRIEF SUMMARY OF THE INVENTION

The current invention relates to a computer-implemented platform designed for the pricing, bidding, award, and management of fleet-based installation services and associated goods; more specifically, an app-based software-enabled platform and system designed to manage services performed on a fleet of vehicles which includes upgrading and updating a graphical component on the external surface of the vehicles of the fleet. The system also allows for the management of other decorative art to be installed on surfaces and the process associated thereof.

### BRIEF DESCRIPTION OF THE DRAWINGS

Certain embodiments are shown in the drawings; however, it is understood that the present disclosure is not limited to the arrangements and instrumentality shown in the attached drawings.

FIG. 1 is a general illustration of the different actions of using a platform and system for the pricing, bidding, award, and management of fleet-based installation services, according to an embodiment of the present invention.

FIG. 2 is a schematic illustration of possible hardware used in a network configuration.

FIG. 3 is a schematic illustration of the different internal hardware layers needed to process information by the different hardware elements shown at FIG. 2 for use as part of the platform shown at FIG. 1, according to an embodiment of the present invention.

FIG. 4 is a schematic representation of how software, such as an app-based software, can be used over a series of network servers to help enhance the software layer of the different hardware elements shown at FIG. 2 for use with a platform as shown at FIG. 1, according to an embodiment of the present invention.

FIGS. 5 and 6 are schematic illustrations of the different menus and options given to users of the system and platform as shown at FIG. 1, according to an embodiment of the present invention.

FIGS. 7 and 8 are screenshots of user entry and editing from one of the functions described at FIG. 5, according to an embodiment of the present invention.

FIGS. 9 and 10 are screenshots linked with project site entry and management from one of the functions described at FIG. 6, according to an embodiment of the present invention.

FIGS. 11, 12, and 13 are screenshots of subsequent details linked with the different functions described at FIG. 6, according to an embodiment of the present invention.

FIG. 14 is an illustration of the details of the steps of operation of the app of an installer, according to an embodiment of the present invention.

FIG. 15 is a screenshot of subsequent details linked with the different functions described at FIGS. 5 and 6, according to an embodiment of the present invention.

FIGS. 16 and 17 are illustrations of the different modules and pages of the app shown at FIG. 14, according to an embodiment of the present disclosure.

FIGS. 18 through 26 are illustrations of secondary modules and pages of the app shown at FIG. 14, according to an embodiment of the present disclosure

FIG. 27 illustrates a dashboard to make it easier for installers to start a new job.

### DETAILED DESCRIPTION OF THE INVENTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

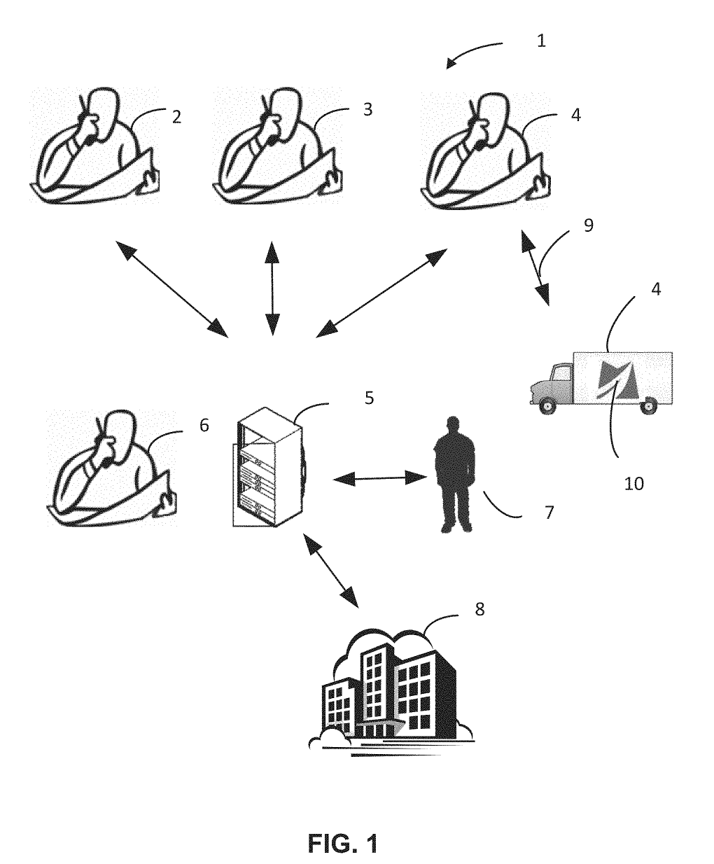

FIG. 1 is a general illustration of the different actions of using a platform 1 for the platform and system for the pricing, bidding, award, and management of fleet-based installation services, according to an embodiment of the present invention. At the heart of the platform is a manufacture/production facility 8 where goods are ordered, produced, packed, and shipped. As shown, in the case of fleet-based goods and associated services, a vehicle 4 is shown having on it an illustration 10 which, for example, was produced by the facility 8. A fleet owner 7 can use the system directly or rely on help from a service provider 4 to help install 9 the illustration 10 on the vehicle 4.

In an embodiment, the platform and associated system 1 as shown is app-based or software-based and resides on a server 5, allowing a person 6 at the facility 8 to coordinate the work to be performed while the illustration 10 on the vehicle 4 may be created and installed by either a client 7 or by an agent 2, 3, or 4. What is also shown is a system where multiple agents 2, 3, and 4 can bid and interact with the system in a very unique and particular way resulting from use of computer technology to resolve this issue. As shown, the platform 1 as generally construed may include the different actors accessing the system using different types of electronic devices. In addition, pagination is incorporated in the platform and associated system pages.

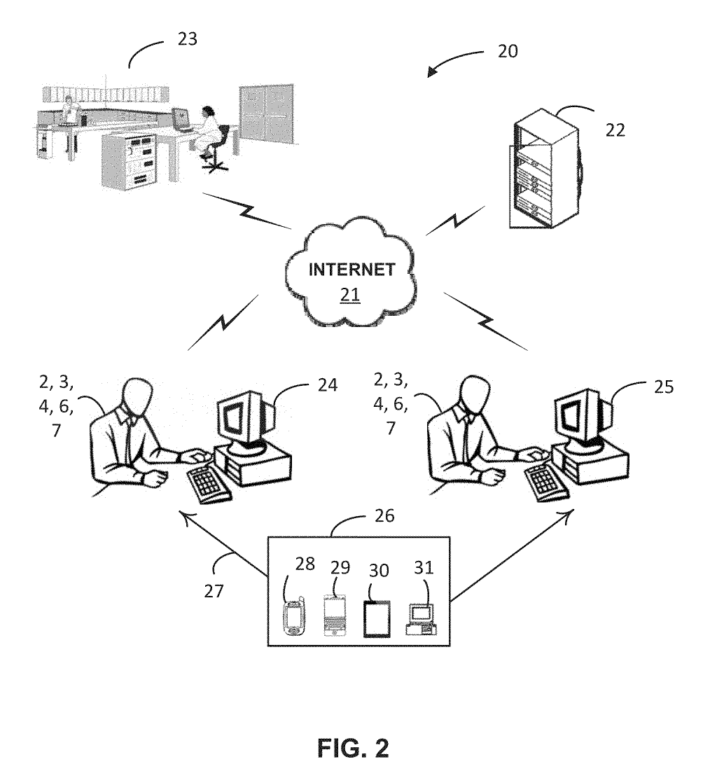

FIG. 2 is a schematic illustration of possible hardware used in a network configuration. Back in 1990, when the Internet was made available to the public, few were familiar with the general interconnectivity of the hardware elements used in any platform or system 1. To enable patent applications, much description of the interconnectivity of these elements became necessary. With time, those of ordinary skill in the art realized how each of these elements and pieces, either in hardware and/or software, operate. To help with this disclosure, what is described hereafter is one configuration of how different elements can operate in tandem.

FIG. 2 shows at the center 21 how the Internet can be used as the protocol of communication using, for example, the HTML protocol. Other networks are also contemplated; for example, wireless networks, internal networks, or other non-HTML networks. As the current platform is expanded and new technology arrives, one of ordinary skill will know that the concepts shown herein can be applied to other networks, and to new technology as currently used over the Internet and wireless networks.

Shown is a remote data server 22, used sometimes to store data used by any software application. For example, in recent years Cloud technology allows for more fluid data management by relying on a network of servers 22 located in different physical locations around the world. As shown, different rooms 23 are connected to the Internet to help manage the system, offer users rights and manage the flow of data. As shown, different pieces of electronics 24 and 25 are in turn connected to the Internet 21 using their own communication protocols to help large numbers of users get access. As shown, the users may be individuals 2, 3, 4, 6, or 7, as shown at FIG. 1. To help the reader understand, while the illustration shows desktop computers 24 and 25, over time users have become more familiar with less bulky systems and equipment capable of also accessing the Internet 26. For example, today's wireless phones now offer owners almost full surfing capabilities through browsers and double capacity transceivers. As shown, users 2, 3, 4, 6, and 7 can use a desktop 31, a tablet 30, a smart phone 29 or a simple cell phone 28. In each case, the users 2, 3, 4, 6 and 7 simply connect 27 the device 26 using access and password features on a software layer. What is not described but is known is how the different ports and communication protocols interconnect using normal connectivity technology. For example, modern tablets can connect through wireless connection, data connection over phone networks, by using Bluetooth®, or by any other data transfer standard. In addition, the platform and the system will provide users the option to recover passwords and contact the system administrator. Questions from users through a “Contact Us” button can be logged into the system and promptly responded to in case of any issues.

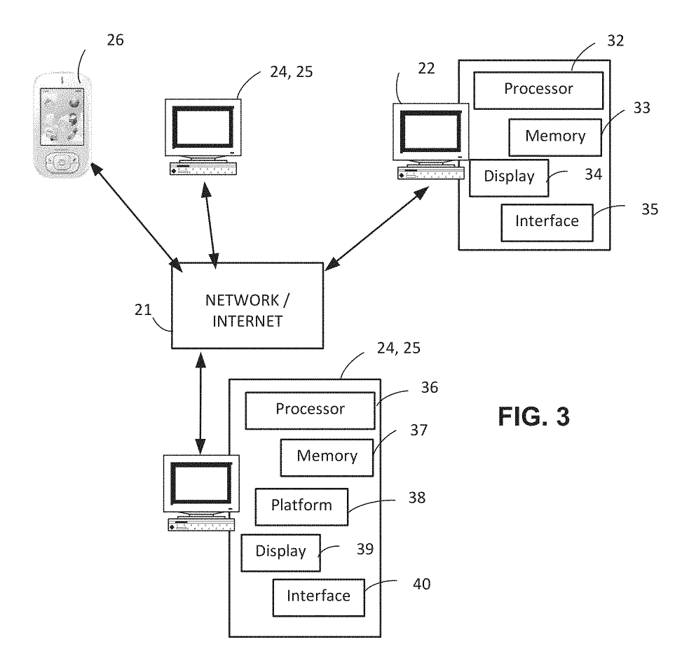

Now that the general structure of users as shown at FIG. 1 has been explained and the overall network configuration of hardware 20 as shown at FIG. 2 is accessed by these different users, we will next explain how each of the devices 26 can host and empower multiple types of software to operate within these devices alongside (when needed) phone communication. FIG. 3 is a high-level schematic of the different internal hardware layers to process information by the different hardware elements shown at FIG. 2 for use as part of the platform shown at FIG. 1, according to an embodiment of the present invention.

Illustrated here are the different elements 22, 24, 25, and 26 connected to the network 21. What is illustrated is how each of these devices has at least one processor 32, 36 which requires memory 33, 36 to operate. On the memory is written software instructions, and each of the devices relies on multiple layers of hardware technology which operates to empower ports, clocks, and other key features including providing the capacity to run programs in memory and then execute the program in a way which can result in output to be processed by the system. These devices also generally have a display 34, 39 of one type or another to interact with the user, and also have an interface 35, 40 of one type or another such as a keyboard or a mouse, to help exchange information with the user. As shown, the platform 38 or executed software used in the current invention is shown on the device 24, 25. This is designed to illustrate generally software applications executing on the device 24, 25 for one or multiple uses. While this description is broad and general, at the current moment in time it is sufficient to empower one of ordinary skill to understand how the below-described system will be implemented without undue experimentation and testing.

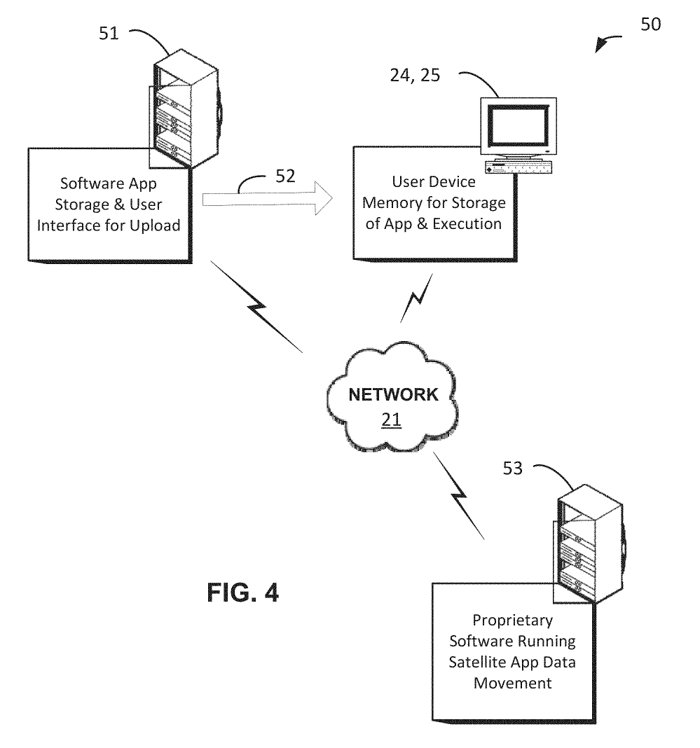

Recently, with the expansion of connectivity to handheld portable devices, software which once was confined to desktops or servers now has migrated to these devices. A remote store on a server houses multiple “apps” (i.e., an executable file in .app format) which can be uploaded directly by a user into the memory of a portable device for execution. Most of these apps then connect via wireless technology to a remote server where the main software application resides and operates. These apps often serve as satellite software capable of interacting with a remote base for multiple functions. Since this technology has greatly expanded in the last decade, FIG. 4 is a schematic representation of how software, such as app-based software, can be used over a series of network servers to help enhance the software layer of the different hardware elements shown at FIG. 2 for use with a platform as shown at FIG. 1, according to an embodiment of the present disclosure. As for the above-suggested embodiments, this one is simply illustrative and not designed to limit the platform in any way.

Apps, once they are programmed, are uploaded using an online portal onto a service provider; for example, the App Store® from Apple®. This is shown at FIG. 4 as server 51. Users will then access the server 51 via the network 21 and, using their own devices, upload the app 52 required from the server 51. Once added to the memory of the device 24, 25, it will be executed and an icon-based interface will help a user launch the app locally. Using the network 21, once the App is launched, it will reach out to a second remote server 53 where data stored on the main software executes and is in contact with other parts of the system. Since this technology is rather new, it is expected this process of sharing and managing apps locally and remotely will evolve with time.

Currently, many software programs use a local HTML browser installed on the computer, along with their associated displays and interfaces, for example tablets, cell phones, portable or fixed computers with a commercial browser tool such as Internet Explorer@, or Mozilla Firefox® to exchange information for the most part in the form of HTML script and data linked with the HTML script and display based on the format of the browser. The platform software 8, while programmed in any of multiple programming languages, relies on any one of multiple database tools, and can be made to read and generate content that can be accessed by the remote HTML browsers.

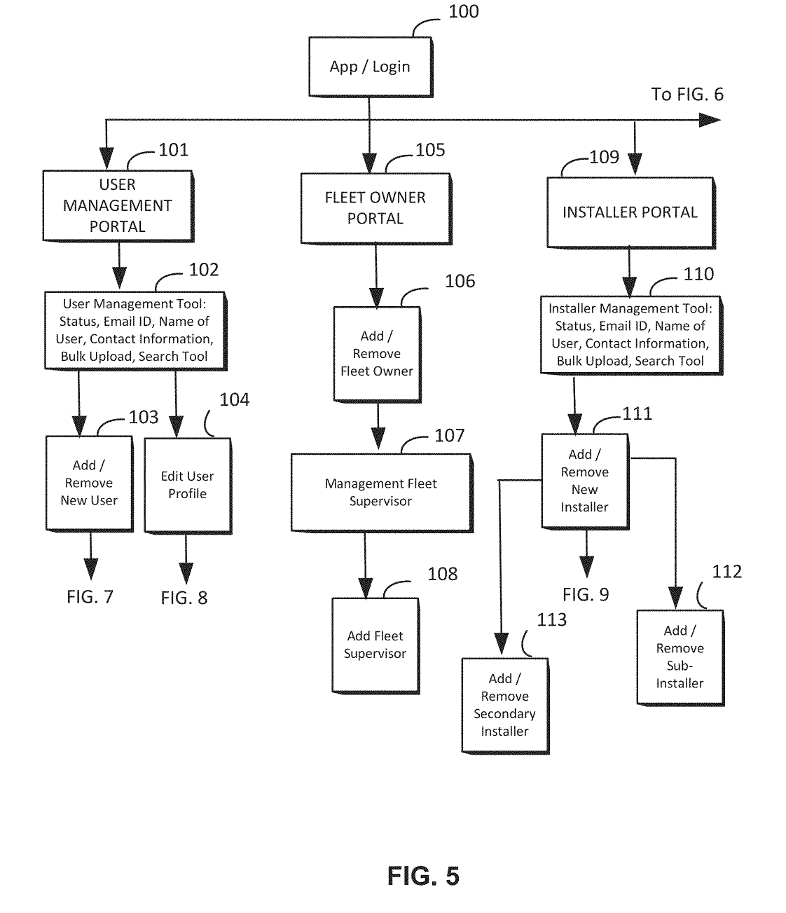

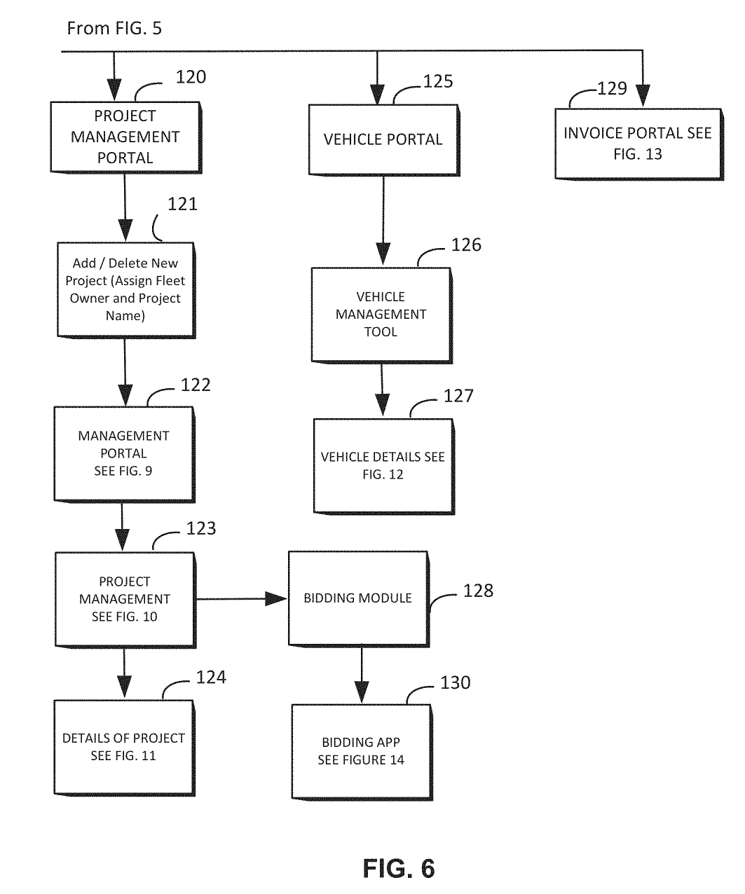

Turning back to FIGS. 5 and 6, these are schematic illustrations of the different menus and options given to users of the system and platform as shown at FIG. 1, according to an embodiment of the present invention. The platform as shown at FIG. 1 and the system found on a server includes a login feature 100, where a user is given multiple different options. Depending on the role of the user and the priority given, some of these functions 101, 105, 109, 120, 125, and 129 may or may not be available. Generally speaking, all of these functions will be available to a web administrator, while other users may have differing levels of access to these functions. A first main menu allows a person to navigate between (a) home, (b) user, (c) fleet owner, (d) installer, (e) project, (f) vehicle, and (g) invoicing.

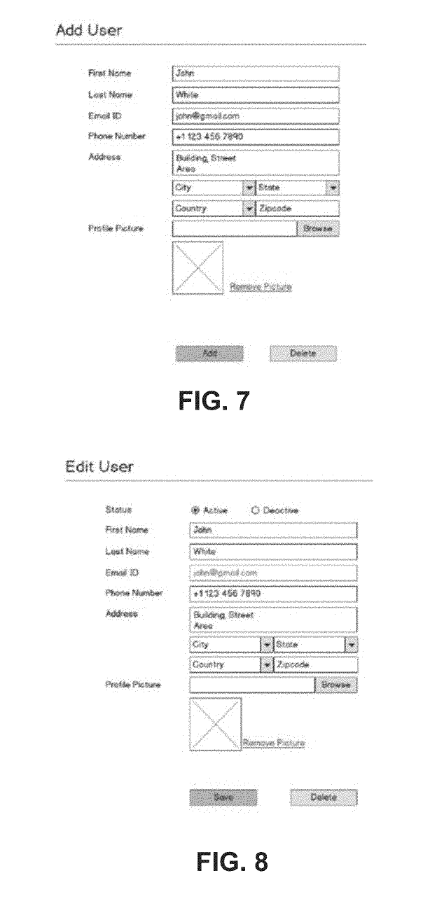

A user clicking on (b) user will be sent to the user management portal 101, which includes multiple functions. On a table or any other easy-to-read function, new users 103 and added and then edited 104 as shown with greater detail at FIGS. 7 and 8. The tool is designed to offer easy indexing and search bars. For example, users can be displayed by status, e-mail ID, first name, last name, and phone number. The system can include buttons like for a bulk upload of data, the addition of a new user.

FIG. 7 shows, for example, one embodiment of a tool to help enter new user information and FIG. 8, which is relatively similar, offers information to help show the step of editing user information. Personally identifiable information is often entered, such as a picture, coordinates, and contact information. Users can be given a status of “active” or “inactive” at this step to help manage the user volume. For example, as a corporation gains new clients and loses some, some users can go from active to inactive. The same way, the person in charge of the platform and system, as shown at FIG. 1, can enter all of the firm's employees as active.

So in addition to “users” of the platform and system, next are entered “fleet owners” 105 into the portal as shown on FIG. 5. The same way, new fleet owners are entered and edited 106 using a similar interface as shown. One of the key differences is that these fleet owners are entered with additional information, such as a company name, a billing address, and contact information relating to their business.

As part of this platform and system, a client owns a “fleet” of cars or vehicles. An action tab on a table is given which includes the way to edit the profile of the fleet owner, and also to add “projects,” add “sites,” and also add “users.” As shown at 107, a fleet supervisor 7 on FIG. 1 is then named with a tool 108 to help manage the fleet of vehicles. The fleet supervisor is associated with the fleet generally and one fleet can have multiple supervisors—for example, if the fleet is nationwide.

Next the installer portal 109 allows for entry of different installers 2, 3, 4, as shown at FIG. 1. These installers also have personally identifying information 110 and can be added 111 using the same type of interface but can also add information such as the name of the corporation they represent, the projects they have won (after bidding), and the associated invoices, and also the name of sub-installers and secondary installers. These different sub-installers 112 and secondary installers 113 can be added and edited also using the same system as defined above.

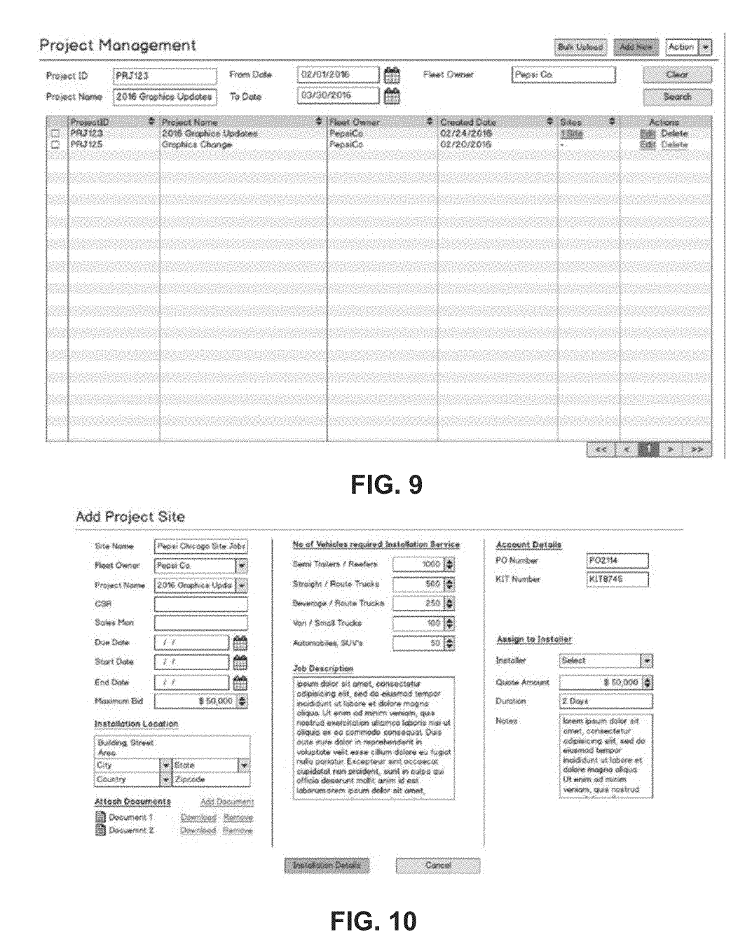

Returning to FIG. 6, in a project management portal 120, new projects, can be created 121 and assigned to fleet owners using a project name. FIG. 9 shows how multiple projects with their own respective IDs can be added linked with a project name. These projects are then assigned a fleet owner (i.e., most often a client) and a date. The projects are also given site information as described with greater detail at FIG. 10 and illustrated at FIG. 6 as 123.

One other indexing tool allows for the management of the different projects to be done by sites. One site can be selected, then further indexing tools can allow to follow the numbers of open bidders, and the type of vehicles in the fleet. As shown at FIG. 10, each project site includes key information to be entered. This information includes the site name, the fleet owner picked from a dropdown menu from entered fleet owners, a project name taken from a dropdown menu from project names entered, a CSR, a Sales Agent, dates (due, start, end), and a maximum bid to be entered by the different bidders in the bidding module 128 as shown at FIG. 6. Information is then entered as to the installation location (i.e., geographical location of the vehicles), and the tool includes the ability to attach specifications or other documents useful to the bidder. Then information is entered as to the number and type of vehicles, which requires the installation, the job description, and account details like a purchase order number and other internal numbers like a KIP number. Finally, the project either can be assigned to an installer at a fixed amount or can be done after bidding has been closed. The same way new projects can be entered, they can also be viewed and edited.

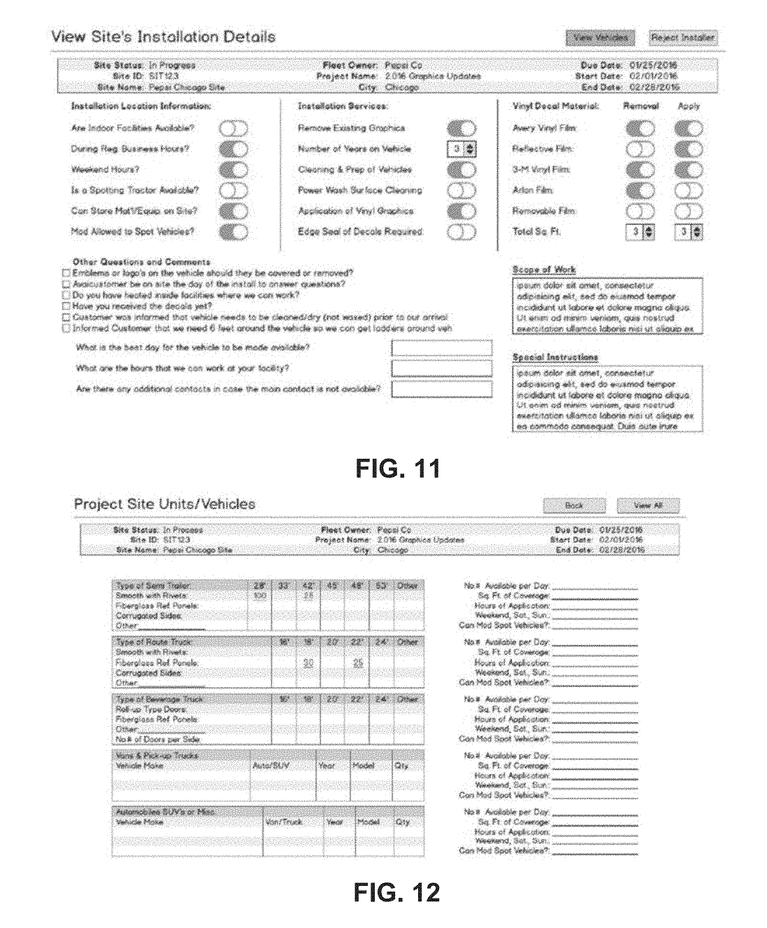

A button allows a person to see installation details as shown at FIG. 11 with greater detail. These are site installation details useful for the installer to quote and perform the work. This information includes data like (a) a bar data summary with dates, names, sites, and other key information, (b) location information such as indoor facilities' availability, business hours open, a capability to conduct the work over the weekend, the use of a spotting tractor, the equipment onsite, and the modification of spot vehicles, (c) installation services like the need to remove existing graphics, the age of the vehicles, the need to clean the vehicles, the need to power wash the vehicles, the application of vinyl graphics, and the edge seal of the decals, (d) the type of vinyl decal material such as, for example, Avery® vinyl, reflective film, 3-M™ film, Arlon film, a removable film, and the total square footage of the removal and application.

Detail data also includes information such as if there are emblems or logos on the vehicle that need to be covered or removed, if the client will be present to help guide the work, if the stock has been shipped and received on-site, the need to clean and wax the vehicles, and the need to park the vehicles in a very precise way. The system also allows for special instructions to be entered and the scope of work to be better defined. A tool also allows a person to view the vehicles to make certain of the extent of the work to be performed.

A tool allows for the management of bids 128 for each project. This tool also allows for the award of the work to one bidder of choice. Once again, the use of the tools above allows the installers to have a full control over the work to be conducted in time, specification, and requirements from the client. This results in a lower bid as this bidder no longer needs to keep safety margins as while bidding.

Next, as shown at FIG. 6 is a vehicle portal 125, where a vehicle management tool 126 allows the entering of data as to the fleet of vehicles. As shown at FIG. 12, and shown at 127, after a management tool is used, details can be secured as to the vehicles themselves. The management tool allows, for example, for before-and-after pictures to be entered. For each vehicle, data is shown at FIG. 12 to help a person ready to install a decal on a vehicle to understand more detail. For example, for each type of vehicle (semitrailer, route truck, beverage truck, pickup truck, etc.) will be given length, finish, number of rivets, panels, sides, etc.

In addition, the vehicle portal will be able provide information to customers about their current fleet status. The vehicle portal will allow for import of all the vehicles that a customer has into a vehicle pool. As a unit is entered into the system by the installer, the VIN, unit number, or license plate will be pulled into the app which will be able to track what trailers or vehicles have been removed out of their pool of vehicles. This will provide have good information to customers about their current fleet status.

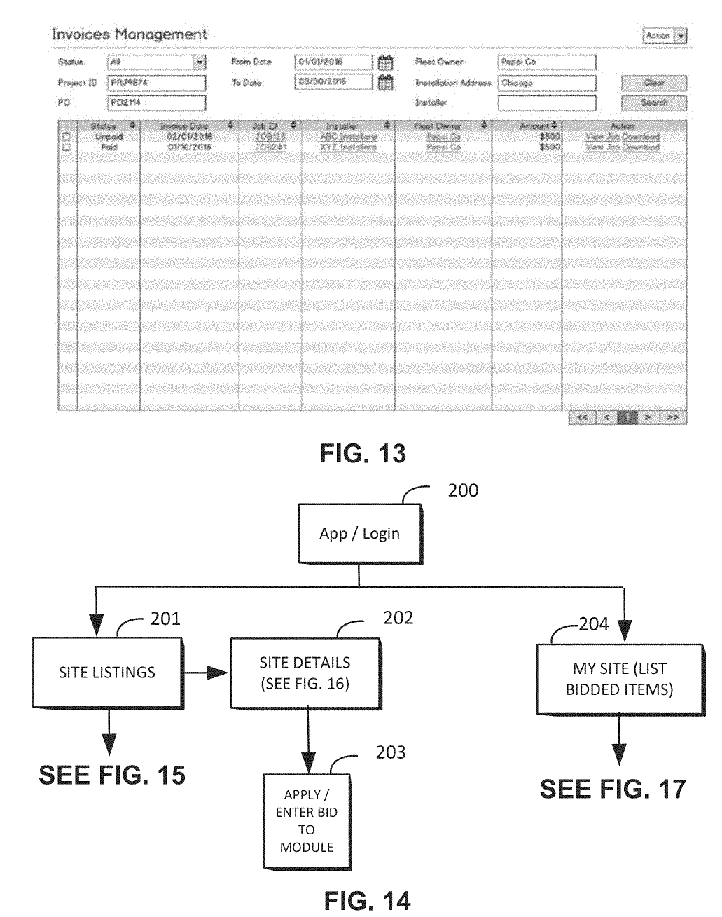

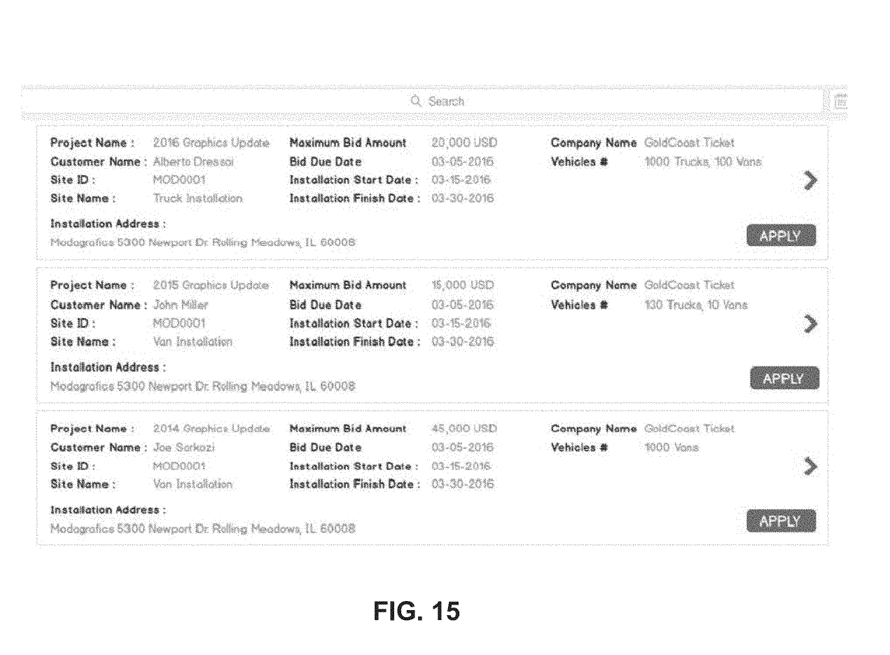

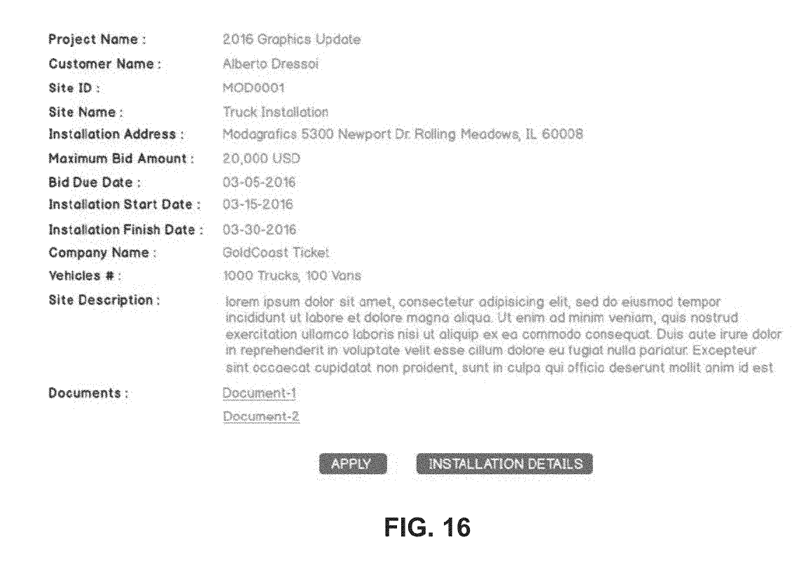

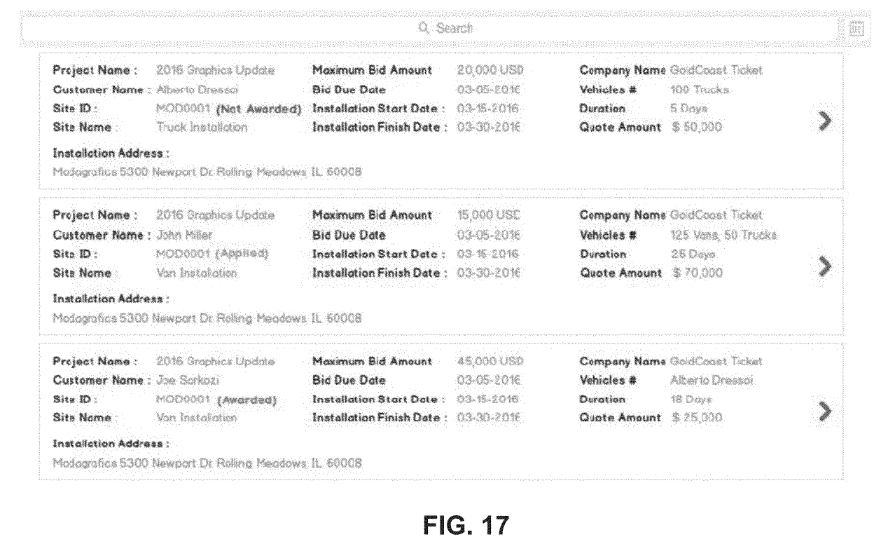

FIG. 6 shows an invoice portal 129, which is shown with greater detail at FIG. 13, where each invoice is managed for processing, payment, and for association as shown. The managing of invoice includes auto-calculating the invoice amount per set price of the invoices. FIG. 6 shows the bidding App 130, as shown with greater detail at FIG. 14 structurally, which includes a login 200, a site listings 201 of active bids, each with a detail tool 202 shown at FIG. 16, a bidding module 203 and a data summary page 204 where all past and ongoing bids are listed. In addition, the invoice management can auto-calculate the invoice amount per the price set from the application so that users will know that they are being invoiced for the same amount as agreed with the installers.

In addition to notifying the customer, the successful bidder (and other bidders) can be notified. The successful bidder will be notified of the job details, the customer contact information, the timing schedule, the parts and direct contact information for the client. FIG. 13 is an illustration of the app page where an onsite button is presented to an engineer, according to an embodiment of the present invention.

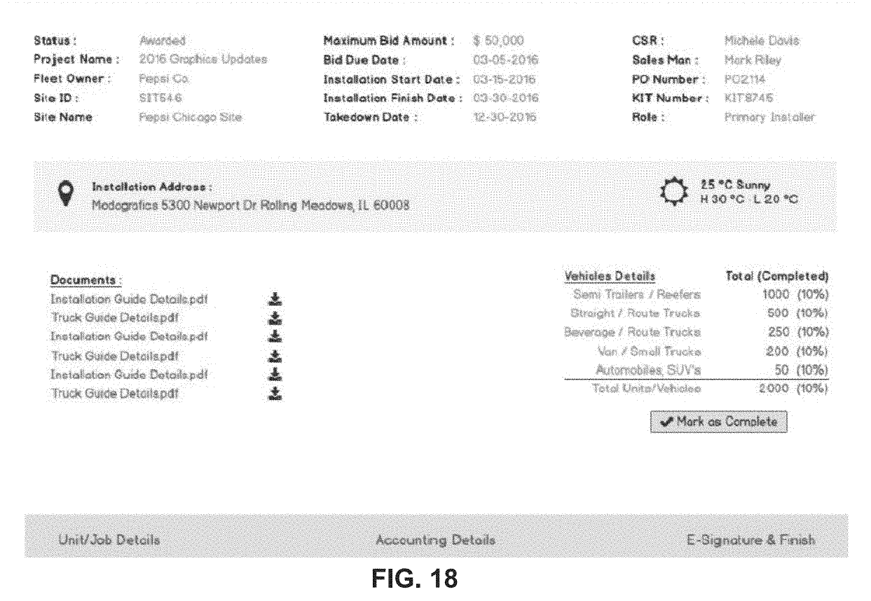

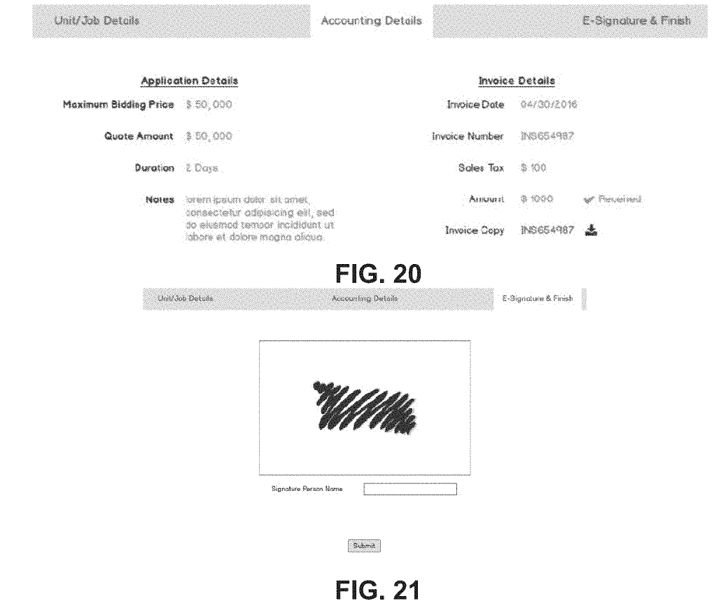

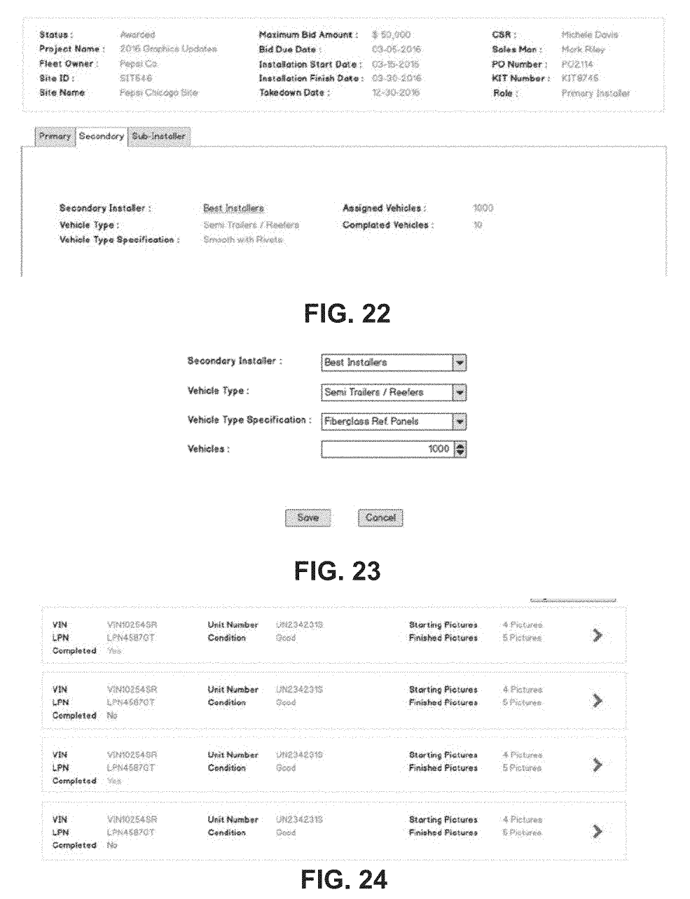

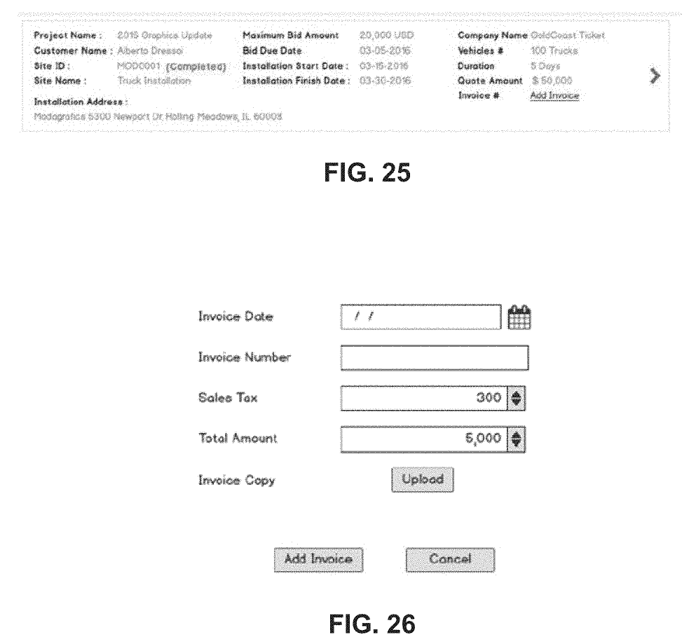

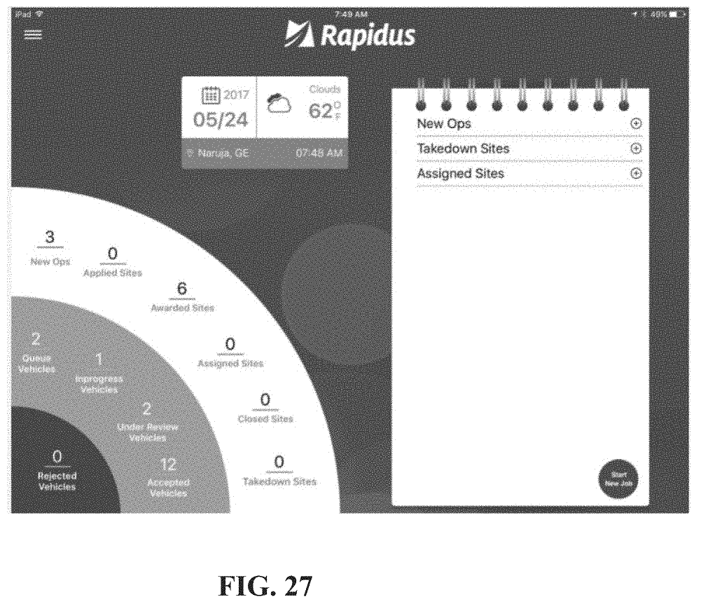

FIGS. 18 through 26 illustrate similar pages and entry data tables that can be implemented on a portable wireless device instead of the main system by a user or any other actor. FIG. 27 illustrates a dashboard to make it easier for installers to start a new job.

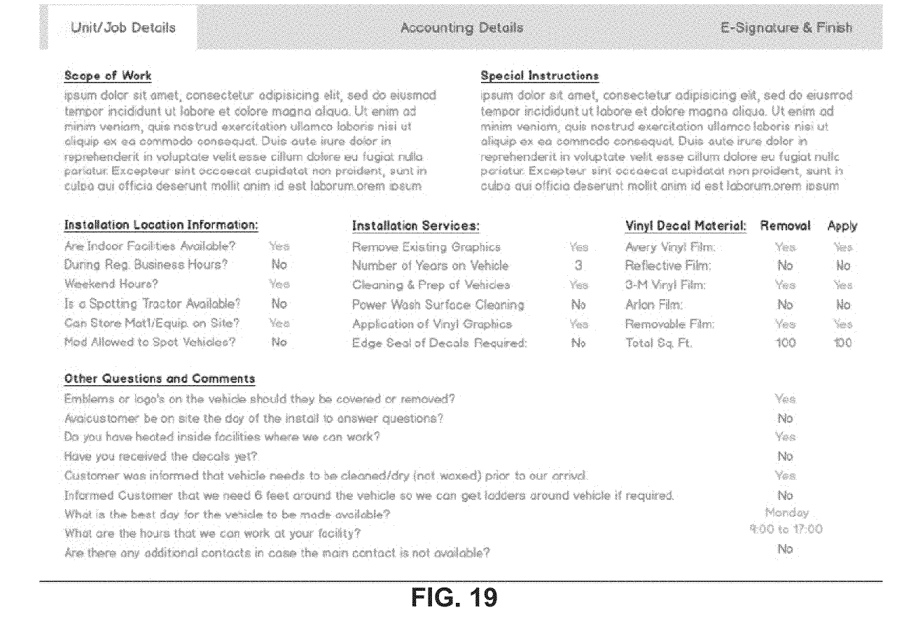

In an embodiment, the platform includes a tool that displays the current or forecasted weather conditions at an installation site. For example, as shown in FIG. 18, a user may be provided with a screen that depicts the installation address along with the current weather conditions. This enables the user to account for weather conditions when undertaking a project. In an embodiment, the system is configured to pull weather information from one or more databases, either located locally to the system or remotely (i.e., over the internet). Further, as shown in FIG. 19, in an embodiment, the platform also provides details regarding whether indoor facilities are available at the installation site, enabling a user to determine whether weather will have a significant impact on a given project.

In an embodiment, the platform is configured to provide geo-tracking of the various items involved in a project (e.g., of the various vehicles in a fleet to be painted). The platform is configured to update the installation address to reflect the actual location of the vehicle, enabling a user to quickly determine the installation location.

In an embodiment, the system is configured to track the status of each individual vehicle in a fleet of vehicles to be painted, and display statistics to a user such as the percentage of the fleet that has already been completed for a given project. In an embodiment, the system provides tools enabling a user to view the percentage of a fleet that has already been completed using various filters to sort for desired characteristics, such as location, project, or date last painted. For example, a user could determine the number of vehicles that have not been completed at a particular installation site, so as to estimate the time required at that particular site.

In an embodiment, the system is connected to, and configured to receive data from, one or more scanners. These scanners may be portable devices that transmit information to the system remotely (i.e., using a cellular connection to transmit information over the Internet). In an embodiment, the scanners comprise one or more cameras configured to optically obtain written information, such as a vehicle information number. The system can then perform Optical Character Recognition (OCR) on the information to identify scanned vehicle numbers. In another embodiment, the scanners comprise barcode readers configured to obtain information encoded into barcodes. These barcodes may be used, for example, to track the particular vehicles in a fleet of vehicles that have been completed.

In an embodiment, the system can be started from the Dashboard making it easier for installers to start a new job. In addition, the system provides for inventory management via kit incident report and kit tracking information which is able to record how many kits went to a particular site and track how many kits are at a particular site. The system enables the installer to make sure that they have enough kits to install before they run out of kits. In addition, incident report images will be provided which will tie pictures to the incident report. If there is damage for instance, the damage report can be written up and a picture of that damage can be uploaded.

In an embodiment, the vehicle pool is able to import all the vehicles that are with customers. As a unit is entered into the system, the VIN, unit number, or license plate will be pulled into the app and will provide for tracking of vehicles that have been removed from the pool of vehicles. This provides good information to customers about their current fleet status. In addition, an user we will be able to define the size and graphic package, an user defined specification, that a customer has on their trailer from the app. This will provide more flexibility and better information before and after the installation.

What is claimed is:

1. A platform with a computer-implemented software system for the pricing, bidding, award, and management of fleet-based installation services, the system comprising:
a series of vehicles in a fleet, each in need of a design graphic, wherein the fleet is in the custody of a client; said client having at least a client device with a processor, an interface, and a memory connected with the processor for executing a software application uploaded from an app server over a network;
wherein the client device has access to said network for communication with a system for the procurement of services over a client portal through the interface of the client device;
a plurality of installers capable of offering services for the series of vehicles; wherein each installer is located in a geographical region in physical proximity of the fleet of vehicles and having at least an installer device with a processor, an interface, and memory in connection with the processor for executing a software application uploaded from an app server over a network;
wherein the installer device has access over said network to the system for the procurement of services over an app portal over the interface of the installer device;
the system comprising the following software operations:
a user management portal;
a fleet owner portal;
an installer portal;
a project management portal;
an inventory management portal;
a vehicle portal; and
an invoice portal.

2. The platform of claim 1, further comprising of a login tool and a first main menu allowing a user to navigate between (a) home, (b) user, (c) fleet owner, (d) installer, (e) project, (f) vehicle and (g) invoicing.

3. The platform of claim 1, wherein an installer can start a new job from a dashboard.

4. The platform of claim 1, wherein the user management portal includes an user management tool with the following options: (a) add a new user, (b) view/edit information on an user profile, (c) bulk upload, (d) display an user status, email ID, first name, last name and phone number of the user and (e) define the size and the graphic package installed on a fleet of a customer.

5. The platform of claim 1, wherein the fleet owner portal includes an fleet management tool with the following options: (a) add a new fleet owner, (b) edit information of a fleet owner, (c) add a new fleet supervisor, (d) edit information of a fleet supervisor, (e) provide a fleet supervisor with the fleet supervisor management tool, (f) bulk upload and (g) add information on projects, sites and users.

6. The platform of claim 1, wherein the installer portal includes an installer management tool with the following options: (a) add a new installer, (b) view/edit an installer profile, (c) bulk upload and (d) display an installer status, email ID, contact information, name of the corporation, projects won, associated invoices and (e) provide information on installer crew, sub-installers and secondary installers.

7. The platform of claim 1, wherein the project management portal includes a project management tool with the following options: (a) add new projects, (b) assign new projects to fleet owners using a project name and a date, (c) bulk upload, (d) link multiple projects with their own respective IDs with a project name, (e) provide project site information for a project, (f) add a project site, (g) view/edit information about a project site such as site name, fleet owners, project name, installation location, maximum bidding entered by different bidders in a bidding application, (h) provide an indexing tool and (i) provide information on installation location and other details such as site bidders, site installers, types of vehicles for the project.

8. The platform of claim 1, wherein the inventory management portal provides a kit incident report, images and kit tracking information for a particular site.

9. The platform of claim 1, wherein the vehicle portal includes a vehicle management tool with the following options: (a) enter data as to the fleet of vehicles, (b) provide details of the fleet of vehicles, (c) enter before-and-after pictures, (d) provide detail information on the type of vehicles to persons installing decal on the fleet of vehicles, (e) vehicle pool to import all the vehicles including the Vehicle Identification Number (VIN), unit number, license plate number and (f) ability to track the vehicles that have been removed from the vehicle pool.

10. The platform of claim 1, wherein the invoice portal includes an invoice management system with the following options: (a) to associate, manage, process, and pay each invoice and (b) auto calculate the amount of invoice generated per each set of price.

11. The platform of claim 7, wherein the bidding application provides the following options: (a) a login tool, (b) information on site listings of active bids, (c) a bidding module, (d) a data summary page listing all past and ongoing bids, (e) job details, customer contact information and timing schedule to a successful bidder.

12. The platform of claim 1, further configured to provide: (a) weather status at an installation site, (b) geo-tracking of various items of a project, (c) tracking status of each individual vehicle to be painted and (d) percentage of the fleet that has already been completed for a given project.

13. The platform of claim 1, further configured and connected to receive data from one or more scanners, wherein the platform can perform Optical Character Recognition on the information to identify scanned vehicle numbers.

14. The platform of claim 13, wherein the scanners further comprises of barcode readers configured to obtain information encoded into the barcodes.

15. A computer-implemented software system for the pricing, bidding, award, and management of fleet-based installation services, the system comprising:
a system for the pricing, bidding, award, and management of fleet-based installation services by a client having at least a client device with a processor, an interface, and a memory connected with the processor for executing a software application uploaded from an app server over a network;
wherein the client device has access to said network for communication with a system for the procurement of services over a client portal through the interface of the client device;
the system also accessed by a plurality of installers capable of offering services for the series of vehicles; wherein each of said installer is located in a geographical region in physical proximity of the fleet of vehicles and having at least an installer device with a processor, an interface, and memory in connection with the processor for executing a software application uploaded from an app server over a network;
wherein the installer device has access over said network to the system for the procurement of services over an app portal over the interface of the installer device;
the system comprising the following software operations:
a user management portal;
a fleet owner portal;
an installer portal;
a project management portal;
an inventory management portal;
a vehicle portal; and
an invoice portal.

16. The system of claim 15, further comprising of a login tool and a first main menu allowing a user to navigate between (a) home, (b) user, (c) fleet owner, (d) installer, (e) project, (f) vehicle and (g) invoicing.

17. The system of claim 15, wherein an installer can start a new job from a dashboard.

18. The system of claim 15, wherein the user management portal includes an user management tool with the following options: (a) add a new user, (b) view/edit information on an user profile, (c) bulk upload, (c) display an user status, email ID, first name, last name and phone number of the user and (e) define the size and the graphic package installed on a fleet of a customer.

19. The system of claim 15, wherein the fleet owner portal includes an fleet management tool with the following options: (a) add a new fleet owner, (b) edit information of a fleet owner, (c) add a new fleet supervisor, (d) edit information of a fleet supervisor, (e) provide a fleet supervisor with the fleet supervisor management tool, (f) bulk upload and (g) add information on projects, sites and users.

20. The system of claim 15, wherein the installer portal includes an installer management tool with the following options: (a) add a new installer, (b) view/edit an installer profile, (c) bulk upload and (d) display an installer status, email ID, contact information, name of the corporation, projects won, associated invoices and (e) provide information on installer crew, sub-installers and secondary installers.

21. The system of claim 15, wherein the project management portal includes a project management tool with the following options: (a) add new projects, (b) assign new projects to fleet owners using a project name and a date, (c) bulk upload, (d) link multiple projects with their own respective IDs with a project name, (e) provide project site information for a project, (f) add a project site, (g) view/edit information about a project site such as on site name, fleet owners, project name, installation location, maximum bidding entered by different bidders in a bidding application, (h) provide an indexing tool and (i) provide information on installation location and other details such as site bidders, site installers, types of vehicles for the project.

22. The system of claim 15, wherein the inventory management portal provides a kit incident report and kit tracking information for a particular site.

23. The system of claim 15, wherein the vehicle portal includes a vehicle management tool with the following options: (a) enter data as to the fleet of vehicles, (b) provide details of the fleet of vehicles, (c) enter before-and-after pictures, (d) provide detail information on the type of vehicles to persons installing decal on the fleet of vehicles, (e) vehicle pool to import all the vehicles including the Vehicle Identification Number (VIN), unit number, license plate number and (f) ability to track the vehicles that have been removed from the vehicle pool.

24. The system of claim 15, wherein the invoice portal includes an invoice management system with the following options: (a) to associate, manage, process, and pay each invoice and (b) auto calculate the amount of invoice generated per each set of price.

25. The system of claim 21, wherein the bidding application provides the following options: (a) a login tool, (b) information on site listings of active bids, (c) a bidding module, (d) a data summary page listing all past and ongoing bids, (e) job details, customer contact information and timing schedule to a successful bidder.

26. The system of claim 15, further configured to provide: (a) weather status at an installation site, (b) geo-tracking of various items of a project, (c) tracking status of each individual vehicle to be painted and (d) percentage of the fleet that has already been completed for a given project.

27. The system of claim 15, further configured and connected to receive data from one or more scanners, wherein the system can perform Optical Character Recognition on the information to identify scanned vehicle numbers.

28. The system of claim 15, wherein the scanners further comprises of barcode readers configured to obtain information encoded into the barcodes.
